(19) United States
(12) Patent Application Publication
(10) Pub. No.: US 2012/0263938 A1
(43) Pub. Date: Oct. 18, 2012

(54) METHOD OF PRODUCING POROUS METAL OXIDE FILMS USING TEMPLATE ASSISTED ELECTROSTATIC SPRAY DEPOSITION

(75) Inventors: Benjamin Paul, Magdeburg (DE); Sergey Sokolov, Rostock (DE); Ralph Kraehnert, Berlin (DE)

(73) Assignee: TECHNISCHE UNIVERSITAET BERLIN, Berlin (DE)

(21) Appl. No.: 13/502,610

(22) PCT Filed: Oct. 20, 2010
(86) PCT No.: PCT/EP2010/065803

§ 371 Date: Jun. 26, 2012

(30) Foreign Application Priority Data
Oct. 20, 2009 (EP) 09173505.0

(51) Int. Cl. B05D 1/04; B32B 3/26; B05D 3/02

(52) U.S. Cl. 428/312.8; 427/458

(57) ABSTRACT

The present invention relates to a method of producing porous metal oxide films on a substrate using template assisted electrostatic spray deposition (ESD). Thereby it is possible to produce both mesoporous and macroporous films which have a predefined pore morphology. In addition hierarchically structured meso- and macroporous films can be produced. The present invention also concerns the produced porous films and their use in catalysis, power storage, sensing and compound separation.

The present invention relates to a method of producing porous metal oxide films on a substrate using template assisted electrostatic spray deposition (ESD). The present invention also concerns the produced porous films and their use.

Thin porous metal oxide films find applications in various different technical fields including gas sensing and separation, catalysis, power storage and generation, biology and medicine. These applications can benefit from enhanced surface area and high surface to volume ratio, which can be realized in nanocrystalline porous structures.

Among commercial metal oxide films, titanium dioxide holds one of the leading positions with its wide use in water and air purification, gas sensing and photovoltaic cells. Hence, significant effort has been devoted to developing synthetic routes to porous titanium dioxide layers, wherein pore connectivity, size and volume can be effectively controlled. Known synthesis routes for metal oxide films with templated porosity rely mostly on dip-coating or spin-coating of substrates. However, both methods suffer significant limitations when faced with large substrates and/or substrates with a micro-structured surface.

A further disadvantage of template-assisted dip-coating is that only mesoporous metal oxide films can be produced. In this method, the coating solution contains metal precursor and organic templates, preferably polymers, in a volatile solvent. The polymers in solution form micelles whose size and shape can be controlled by varying concentration and nature of the used polymers. When the substrates are withdrawn from the coating solution, the micelles organize in ordered arrays on the substrate surface via evaporation-induced self-assembly process while the inorganic precursor is trapped in the interstices between the micelles. During calcination, the inorganic precursor is converted into the metal oxide while the organic templates are burned out leaving behind ordered pores. U.S. Pat. No. 6,270,846 B1 discloses such an evaporation induced self-assembly method to prepare thin films. A mixture of a silica sol, a surfactant and a hydrophobic polymer solved in a polar solvent are applied onto a substrate to form thin films. The evaporation of the solvent results in self-assembly of the silica surfactant mesophase, wherein the hydrophobic solvent is used as a swelling agent to form the pores.

However, the resulting mesoporous films are limited by the maximum thickness of the films produced. Films produced in a single coating cycle are typically less than 1 μm thick. Theoretically coating with multiple layers increases overall film thickness, but raises issues with the structural stability of the layers. Even if a reliable synthesis for thicker films is established, increasing diffusion path in the mesoporous regime imposes transport limitations rendering deeper pore layers poorly accessible or isolated from the environment above the film.

Alternatively macroporous film can be prepared which show a higher film thickness and better diffusion. One approach to produce macroporous films of metal oxides is the template-assisted sol-gel process, wherein polymer microspheres are used as template. A stable colloidal suspension of template particles is dried onto the substrate surface leaving behind a film assembled of microspheres. Then the template arrays are infiltrated with inorganic precursors, which are converted into metal oxides in a thermal treatment while templates are removed. Film thickness, pore size, mechanical stability and final phase composition are controlled by several variables in preparation procedure, such as a method of drying, initial concentration of the polymer in the suspension, microspheres size and size distribution, inorganic precursor concentration and calcination conditions. However, the synthesis is lengthy and laborious and limited to macroporous films.

Electrostatic spray deposition (ESD) is an established method to deposit dense coatings. For example US 2005/0095369 A1 discloses the use of ESD for producing a solid oxide fuel cell. ESD has also been used for the synthesis of macroporous metal oxide films. In this method a precursor solution is transported into the electric field induced between a source (nozzle) and a substrate. The films created in this process can be varied by the precursor concentration, nature of solvent(s), solution feeding rate, applied potential, substrate to nozzle distance, substrate temperature and after treatment. Film thickness can be adjusted by varying deposition time, feeding rate and precursor concentration. For example, spraying of titanium isopropoxide dissolved in a mixture of ethanol, acetic acid and diethylene glycol butyl ether (e.g. available as butyl carbitol) on stainless steel disks which were heated to the boiling temperature of butyl carbitol resulted in a film with highly open reticular structure, wherein the openings were few micrometers across (M. Nomura, B. Meester, J. Schoonman, F. Kapteijn, J. A. Moulijn, Sep. Purif. Technol. 32 (2003) 387). However, precise control over the pore morphology in ESD is not possible up to date because in ESD derived films pores are usually only porous due to gas bubbles formed upon boiling of an atomized solvent. Naturally, solvent droplets vary in size and may assume arbitrary shape and size during boiling and/or drying. Hence differences in pore size and shape between the solidified structure occurred.

It is the object of the present invention to provide an alternative method of production of porous oxide films which overcomes the problems of the state of the art. It is a further object of the present invention to provide a method which is able to produce both mesoporous and macroporous films. Said porous films should have a predefined pore morphology with respect to pore volume, pore size distribution and pore connectivity. It is a further object of the present invention to provide hierarchically structured meso- and macroporous films.

The present invention relates to method of producing a porous metal oxide film on a substrate comprising (a) forming a precursor solution comprising a solvent, at least one metal precursor and at least one pore forming organic template, (b) depositing the precursor solution formed in (a) onto a substrate using electrostatic spray deposition process and (c) thermally treating the product obtained in (b) in an atmosphere having an oxygen content from 0 to 50 vol.-% by following a temperature profile comprising one or more heating ramps, one or more temperature plateaus and one or more cooling ramps. Thereby the metal precursor(s) are transformed into a material readily convertible into metal oxide, the pore templates are removed completely and finally the metal oxide(s) are formed.

In the present invention, electrostatic spray deposition method is used to form porous metal oxide films of a single metal oxide and poly-metal oxides on various substrates, respectively. Therefore a precursor(s) solution comprising the metal precursor(s) and the pore forming organic template(s) taken in appropriate concentrations in a suitable solvent are sprayed upon the substrate surface. Well-defined pores can be formed and their size can be controlled on meso- and macroscale or both by adding suitable hard and/or soft pore forming organic templates into a precursor solution containing the metal precursors. According to the method of the present invention mesoporous (2-50 nm (per IUPAC definition)), macroporous (>50 nm) and hierarchical meso- macroporous structures with strictly defined pore size(s) can be prepared. Pore size, pore structure and porosity in the films produced by this method are directly controlled by the size and the concentration of the pore forming organic templates in the initially formed precursor solution. The precursor solution is deposited onto the substrate by electrospraying and thermally treating.

The use of ESD procedure for the method according to the present invention is very advantageous. ESD uses electrostatic charging to disperse and transport precursor(s) solution onto a surface. Electrical potential applied between the substrate and the nozzle through which the precursor solution is supplied, atomizes the latter and carries charged microdroplets to the substrate. Advantageously deposition of a charged spray on a grounded object is significantly more efficient than the deposition of uncharged droplets. Further the charged droplets are self-dispersing in space due to repellence forces thereby preventing droplet conglutination. Motion of charged droplets can be controlled easily by electric fields, including jet deflection or focusing. The droplet size produced by the method according to the present invention is less than 1 μm with a small droplet size distribution so that pores of nearly uniform size are formed.

Chemical compositions of the films produced by this method may be diverse and the present invention focuses onto single and mixed metal oxides. Combining ESD technique with the usage of macro- and mesostructure pore forming organic templates of defined sizes merges benefits of spraying and coating techniques. Films of increased thickness can be realized through the extended deposition time while pore parameters such as pore volume, size distribution and pore connectivity can be tuned by selecting the pore forming organic template type and size, as well as varying the concentration of the pore forming organic template in the precursor(s) solution and the ratio between macro- and mesostructure pore forming organic templates.

Surprisingly, it was shown by the inventors that mesostructure and macrostructure pore forming organic templates can be used in ESD process, although behaviour of organic templates in ESD-compatible solvents and environment faces crucial limitations. For instance amphiphilic block copolymers may not form micelles in a particular solvent or the solvent(s) where they form micelles may not be suitable for spraying. In addition, many solutions cannot be electro-sprayed since the solution does not form the required jet of fine droplets.

Depending on the used organic templates further problems may occur. For instance polymethyl metacrylate spheres may swell and dissolve in certain solvents. Thus, templates, solvents and spraying conditions must be carefully selected. It was necessary to find a solvent which would not dissolve the organic templates, such as polymethyl metacrylate latex, which was suitable for polymer micelles formation, which formed a stable solution (or a sol) with a metal oxide precursor and which could be atomized by applied electrical potential.

To ensure a uniform substrate coverage, a stable cone jet mode should have been established during spraying, which requires controlling several parameters, such as solution conductivity, permittivity, viscosity, flow rate and voltage. All these often conflicting requirements limit the choice of solvents, organic templates and metal precursors and make the process quite involved.

According to the present invention the at least one pore forming organic template is an ionic or non-ionic surfactant, an amphiphilic block copolymer, a solid organic particle having a mean diameter in the range of 50 nm to 5 μm, preferably in the range of 50 nm to 500 nm or a mixture thereof.

Suitable mesostructure pore forming organic templates are soft templates, such as anionic, cationic, non-ionic surfactants, block copolymers or mixtures thereof. The core property of a surfactant or a block copolymer used as a mesostructure pore forming organic template is its ability to form micelles in a given solvent system. Chains of the block copolymers used have to include hydrophilic and hydrophobic moieties which enable them to form micelles in organic solvents or solutions containing water and solvents miscible with it.

Preferred anionic surfactants are for example sulfates, sulfonates, phosphates, carboxylic acids and mixtures thereof. Suitable cationic surfactants that can be used according to the present invention comprise for instance alkylammonium salts, gemini surfactants, cetylethylpiperidinium salts, dialkyldimethylammonium and mixtures thereof. In another embodiment of the invention non-ionic surfactants having a hydrophilic group, which is not charged, comprise primary amines, poly(oxyethylene) oxides, octaethylene glycol monodecyl ether, octaethylene glycol monohexadecyl ether and mixtures thereof. According to the invention every mixture of one or more anionic, cationic or non-ionic surfactant is a suitable mesostructure pore forming organic template.

In a preferred embodiment of the invention the amphiphilic block copolymer is a di-block, tri-block or multi-block copolymer. The amphiphilic block copolymer is preferably capable for forming micelles in aqueous and non-aqueous solvent. Suitable tri-block copolymers are for instance polyethylene oxide-blockpolypropylene oxide-block-polyethylene oxide, polypropylene oxide-block-polyethylene oxide-block-polypropylene oxide, polyethylene oxide-block-polyisobutylene-blockpolyethylene oxide, polyethylene-block-polyethylene oxide, polyisobutylene-blockpolyethylene oxide or a mixture thereof. Suitable amphiphilic di-block or multi-block copolymers are known to skilled in the art and can be used as well. In a more preferred embodiment polyethylene oxide-block-polypropylene oxide-block-polyethylene oxide is used according to the present invention.

In a preferred embodiment of the invention the ionic or non-ionic surfactant, the amphiphilic block copolymer or the mixture thereof is used in a concentration being above the critical micelle concentration. Suitable concentrations of the mesostructure pore forming organic template are in the range of 0.01 to 5 g/l, preferably in the range of 0.1 to 2 g/l and more preferred in the range of 0.1 to 1 g/l.

Macropores can be produced by adding stable colloidal suspensions of hard pore forming organic templates, such as polymer spheres to the precursor(s) solution. Macrostructure pore forming organic templates can be polymer latex with the spherical particles ranging in size from 50 nm to 5 μm, preferably ranging in size from 50 nm to 500 nm. Colloidal suspensions of polymer spheres have to be stable and compatible with the precursor(s) solution. More specifically, the polymer spheres must not aggregate, swell or dissolve when introduced into the precursor(s) solution, but have to remain well-dispersed through the entire solution volume. The spheres can be composed of polymers that comprise for instance polystyrene, polymethyl methacrylate, styrene-acrylate copolymer, styrene-butadiene-copolymer, nitrile-butadiene-copolymer, pyridine-styrene-butadiene-copolymer or mixtures thereof. In a more preferred embodiment polymethyl metacrylate latex is used as polymer spheres according to the present invention. The solid organic particles are used in the range of 0.1 to 50 g/l preferably in the range of 0.1 to 30 g/l and more preferred in the range of 1 to 10 g/l.

In a more preferred embodiment the pore forming organic template used for the method according to the present invention is a mixture of a soft and a hard pore forming organic template. In particular the pore forming organic template used for the method according to the present invention is a mixture of an amphiphilic block copolymer and solid organic particles. Preferably the amphiphilic block copolymer and solid organic particles are mixed in the range of 20:1 to 1:20, preferably in the range of 10:1 to 1:10, more preferred in the range from 5:1 to 1:5. If macropores in hierarchical structure shall be connected through the openings, the concentration of solid organic particles shall be greater than the concentration of the amphiphilic block copolymer. Thus, in a more preferred embodiment of the invention the ratio of the amphiphilic block copolymer to the solid organic particles is in the range of 1:10 to 1:2, preferably the ratio is in the range of 1:5 to 1:4, most preferred 1:4.5. Combining of mesostructure and macrostructure pore forming organic templates in the precursor(s) solution results in a hierarchical pore structure where mesopores are situated in the walls of macropores thus furnishing high surface area and good transport properties trough the entire film thickness.

Suitable metal oxide precursors that can be used according to the present invention are for instance metal halogenides, metal nitrates, metal sulphates, metal acetates, metal citrates, metal alkoxides or a mixture thereof. The main requirements to metallic precursors are a sufficient solubility in a selected solvent system and the ability to transform into oxides upon thermal treatment altering the deposition while preserving the template-molded structure. Preferably metal alkoxides are used as metal oxide precursors according to the present invention. Suitable concentrations of metal precursors which were used in the method according to the present invention are in the range of 0.1 to 100 mmol/l, preferably in the range of 0.1 to 10 mmol/l and more preferred in the range of 1 to 7.5 mmol/l.

Several solvents can be used according to the present invention. Selected solvent systems should satisfy several criteria, which are for example, the ability to dissolve the metal precursor(s), the suitability for the surfactant/block copolymer to form micelles, compatibility with polymer latex and volatility sufficient for a continuous formation of the templates/metal precursor composite film on a substrate during spraying. Further, the final solution should have such physical characteristics as surface tension, electrical conductivity and density in a range suitable for ESD, which is unique for a particular solvent-metal precursor-surfactant combination.

Suitable solvents according to the present invention comprise a polar organic solvent, preferably a volatile polar organic solvent, a mixture of two or more volatile polar organic solvents or a mixture thereof with water. Preferred volatile organic solvents are alcohols, such as methanol, ethanol, propanol, isopropanol, n-butanol, isobutanol, pentanol, hexanol, tetrahydrofuran, formamide benzaldehyde or mixtures thereof, in particular mixtures of one or more volatile polar organic solvents and water, such as a mixture of alcohol and water, preferably n-butanol and water, formamide and water or tetrahydrofuran and water. The water content in the volatile polar organic alcohol(s) should be in the range of 0-10 wt. %.

The precursor solution for deposition by ESD to the substrate surface is prepared by dissolving metal precursor(s) and pore forming organic template(s) in duly order in a solvent or a mixture of solvents. Alternatively metal precursor(s) and template(s) are dissolved separately in different solvents and then the resulting solutions are combined to the precursor solution. In another embodiment of the invention a precursor solution is formed by adding to a first solvent at least one metal precursor and adding to a second solvent at least one pore forming organic template and combining the first and the second solvent. The resultant precursor solution must be sufficiently stable, in particular metal precursor(s) and pore forming organic template(s) must not aggregate or precipitate for the entire duration of spray deposition.

In another embodiment of the invention the substrate material comprise steel, glass, graphite or other material withstanding the thermal treatment. Substrate materials can be used directly or the substrate surface is pretreated. In a preferred embodiment of the invention the substrate is pretreated by applying a passivation layer onto its surface prior to depositing of precursor solution. In another embodiment of the invention the substrate is pretreated by applying a conductive layer onto the substrate. The latter pretreating is needed, if the substrate itself is an insulator.

According to the present invention the precursor solution comprising the metal precursors and the pore forming organic templates are applied onto the substrate by using ESD. Every standard ESD-system can be used according to the invention. However, the spray-process and the parameters have to be controlled specifically in order to force the templates to form a structure together with the precursors, thereby avoiding demixing and agglomeration processes. Several parameters have to be controlled during spraying, namely applied voltage, nozzle to substrate distance, precursor solution flow rate, substrate temperature and deposition time length. Each of these parameters or a combination thereof may influence the final film morphology. Other variables, apart from the precursor(s) solution composition, exerting influence on the final film morphology are the nozzle inner and outer diameter and the nozzle tip angle. With a given precursor solution and a given geometry of the nozzle, ESD can be operated in several modes which can be controlled by the applied potential and the flow rate. These modes differ in the manner how the precursor(s) solution is atomized and transported to the substrate and include microdripping, spindle, multispindle, oscillating-jet, precession, multijet, and cone-jet modes. From a film deposition perspective, the cone-jet mode is the most desirable mode according to the present invention since it provides a continuous spray with uniformly sized droplets. In a preferred embodiment of the invention the ESD conditions were adjusted to achieve a stable cone-jet spraying mode. However, every other ESD-mode can be used to produce the films according to the present invention.

Typically, the voltage applied between the nozzle and the substrate was in the range of 1 to 10 kV, preferably in the range of 2 to 5 kV and more preferably in the range of 3 to 4 kV according to the method of the present invention. The flow rate of the precursor(s) solution was set in the range of 0.5 to 10 mL/h, preferably in the range of 1 to 5 mL/h and more preferred in the range of 1 to 2 mL/h. The distance between the nozzle tip and the substrate was in the range of 10 to 30 mm and preferably in the range of 10 to 20 mm. Nozzles with tip angles in the range of 14 to 30°, preferably in the range of 15 to 25° and more preferably in the range of 18 to 22° were used according to the present invention. The inner and outer diameters of the nozzles were 0.9 and 1.1 mm, respectively. The substrate temperature was kept in the range of 25 to 250° C., preferably in the range of 50 to 130° C. and more preferred in the range of 70 to 110° C. A suitable deposition time varied in the range of 3 to 60 min, preferably in the range of 3 to 45 min, more preferred in the range of 5 to 30 min.

After finishing the ESD the freshly coated films have to be treated at elevated temperature in order to remove pore forming organic templates and to convert metal precursor(s) into corresponding oxide(s). The treatment can be done in static or dynamic atmosphere that can be composed of normal air or a mixture of oxygen and inert gases, such as nitrogen or noble gases, wherein the oxygen content varies in the range of 0 to 50 vol.-%, preferably in the range of 0 to 30 vol.-% and can be varied during the treatment. Lower oxygen content helps to avoid coke formation during removal of the organic template because the latter de-polymerizes in oxygen depleted atmosphere in 300-400° C. range. However, when templates are removed, oxygen content should be raised to higher values to form metal oxide (MOₓ) from the metal hydrous oxide (M(OH)_{y}O_{x-y}). The temperature profiles followed for thermal treating comprise one or more heating ramps, one or more temperature plateaus and one or more cooling ramps. Specific treatment conditions, i.e. the atmosphere composition and the temperature profile, depend on the requirements for the optimal removal of the pore forming organic template(s) and for the conversion of the metal precursor(s) into corresponding oxide(s). In one embodiment of the invention the atmosphere has to be changed during the course of the treatment. For example, certain acryl-based polymers, such as polymethyl methacrylate, can be almost completely depolymerized at 300-400° C. in a dynamic oxygen-depleted atmosphere and thereby removed substantially cleaner than by combustion in air. Hence, calcination of the films produced from a certain metal precursor solution containing polymethyl methacrylate latex templates may be carried out following a temperature profile containing two plateaus: one in 300-400° C. range to remove the polymer and the other at higher temperature required for metal oxide formation and, if necessary, subsequent phase transformations. Suitable higher temperatures are for instance in the range of 500 to 1000° C., preferably in the range of 500 to 800° C. Passing atmosphere can be changed during the treatment from oxygen-depleted at the first plateau to oxygen-enriched at the second one. A preferred oxygen-depleted atmosphere contains 0 to 5 vol.-% oxygen, more preferred 0 to 3 vol.-% oxygen. A preferred oxygen-enriched atmosphere contains more than 13 vol.-% oxygen, more preferred more than 17 vol.-% oxygen.

In a preferred embodiment of the method according to the present invention the deposition of the precursor solution and part of the thermal treatment of the film are performed concurrently. In particular, the substrate is heated to the temperature at which metal precursors are chemically modified to form solid matter enveloping organic templates, thus forming a composite material preceding porous metal oxide. Advantageously, thereby spraying and thermal stabilization of the coating can be performed in the same setup and possibly already during the spraying process.

The present invention further relates to the products, i.e. the porous films, obtainable by the method according to the present invention. The porous films according to the present invention show a porosity greater than 60%, preferably greater than 70% and more preferred greater than 80%. Such films will benefit applications requiring coatings with high surface area and improved transport properties, i.e. catalysis, power storage, sensing, separation, etc. Thus, the present invention relates further to the use of the porous films according to the present invention as material for catalysis, power storage, sensing and compound separation.

The present invention will be described in greater detail by use of figures and examples which are not intended to limit the invention in any case.

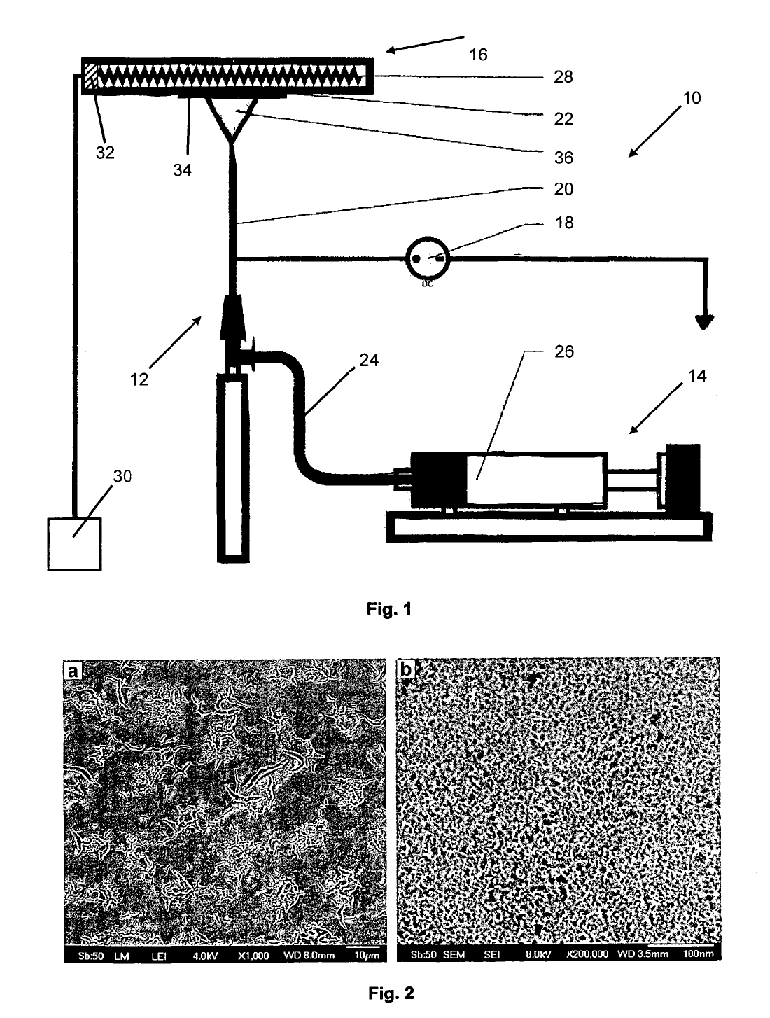

FIG. 1 shows a schematic diagram of the electrostatic spray deposition setup

FIG. 2 shows SEM images of a mesoporous TiO₂-film on stainless steel calcined at 500° C. and measured at 1000× (a) and 200,000× (b) magnification

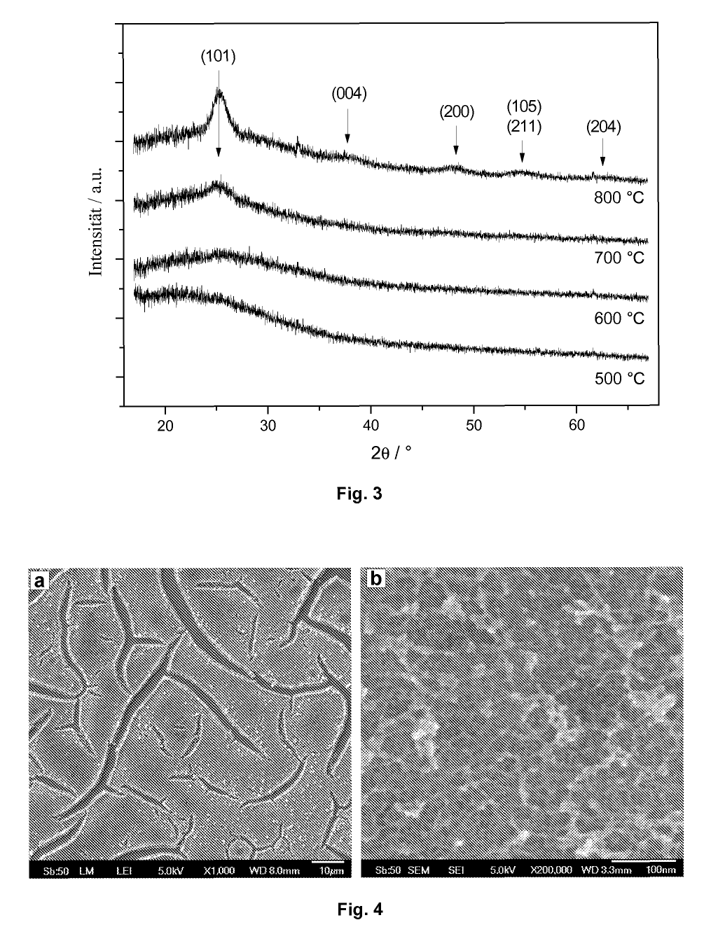

FIG. 3 shows background-adjusted X-ray diffractograms of a mesoporous TiO₂-film on a Si-wafer calcined at 500, 600, 700 and 800° C., respectively

FIG. 4 shows SEM images of a mesoporous TiO₂-film deposited on a Si-wafer calcined at 800° C., wherein images are measured at 1000× (a) and 200,000× (b) magnification

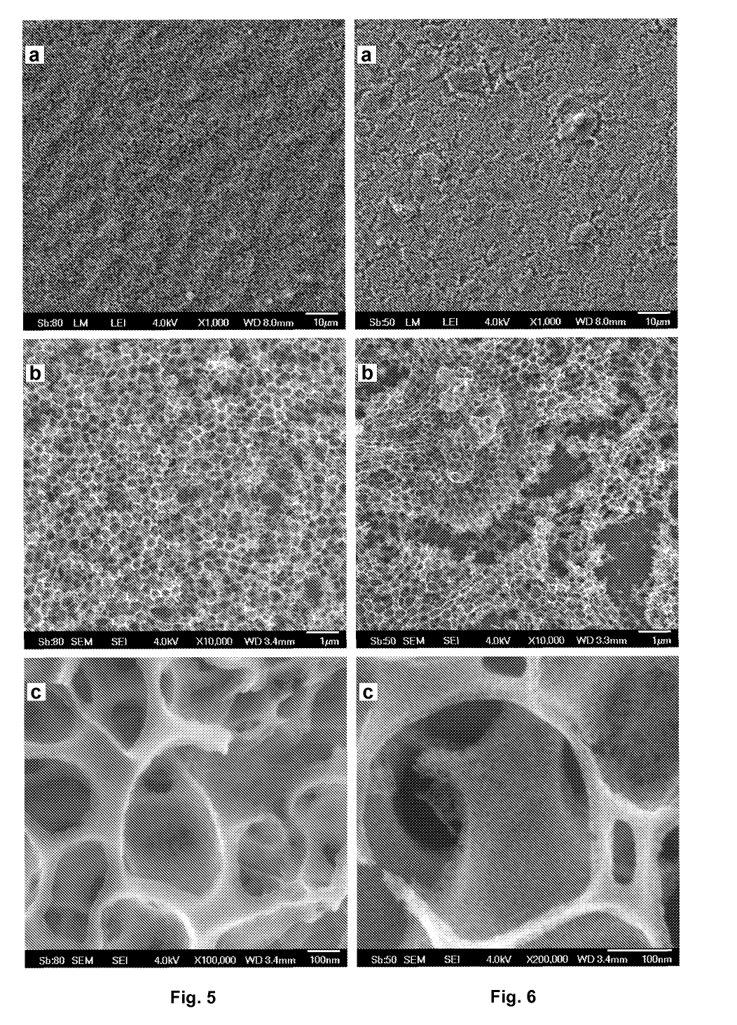

FIG. 5 shows SEM images of a macroporous TiO₂-film on a Si-wafer calcined at 500° C., wherein images are measured at 1000× (a), 10,000× (b) and 100,000× (c) magnification

FIG. 6 shows SEM images of a hierarchically porous TiO₂-film on a Si-wafer calcined at 500° C., wherein images are measured at 1000× (a), 10,000× (b) and 200,000× (c) magnification.

FIG. 1 shows an ESD-setup 10 schematically. The ESD-setup 10 comprises an electrostatic spray unit 12, a liquid-precursor feed system 14 and a temperature control block 16. The electrostatic spray unit 12 comprises a high-DC voltage power supply 18, a stainless steel nozzle 20 and a grounded substrate holder 22. The liquid-precursor feed system 14 comprises a flexible tube 24 and either a peristaltic or syringe pump 26. The temperature control block 16 comprises a heating element 28 and a temperature controller 30 connected to a thermocouple 32. A positive high voltage is applied to the stainless steel nozzle 20 while the substrate 34 is grounded. The precursor solution comprising the metal precursors and the pore forming organic templates is stored in the liquid-precursor feed system 14. Using the pump 26 the precursor solution is guided through the flexible tube 24 into the electrostatic spray unit 12. At the end of the stainless steel nozzle 20 the precursor solution left the electrostatic spray unit 12 in form of a cone jet 36 and is deposited onto the substrate 34 fixed on the substrate holder 22.

### EXAMPLE 1

### Preparation of a Mesoporous TiO₂-Film on Stainless Steel

0.05 M solution of titanium tetraisopropoxide in n-butanol was prepared as solution A. As solution B 7.10 g of Pluronics® P123 block copolymer were solved in 1.00 L of n-butanol. 1.00 mL of solution A was combined with 1.00 mL of solution B and diluted to 10 mL with n-butanol. The final concentrations of tetraisopropoxide and P123 were 0.005 mol/L and 0.71 g/L, respectively. The achieved precursor solution was stirred for 30 min after which it was used for spraying.

Spray deposition was done on 1.4571 stainless steel substrate 34 heated to 80° C. The nozzle 20 was 1.1 mm OD with a tip angle of 21°. The precursor solution was fed through the nozzle 20 with a syringe pump 26 at 1 mL/h rate. The tip of the nozzle 20 was positioned 12 mm below the grounded substrate 34 and a potential of 3.6 kV was applied to the nozzle 34 first and a multijet spraying mode was established. After a short spray impulse the potential was reduced to 3.0 kV and the mode changed to a single cone-jet 36. Deposition was continued for 6 min, then the solution supply and the voltage were cut off and the substrate 34 with the deposited film was removed from the holder 22.

Then the sample was a subject to the thermal treatment following the profile: starting at room temperature; 5 K/min ramp to 80° C.; 80° C. for 4 h; 1 K/min ramp to 500° C.; 500° C. for 0.5 h and cooling to room temperature in flowing air.

The film morphology was characterized by SEM (FIG. 2). FIG. 2 shows secondary electron micrographs of the calcined film at low (1000×) (a) and high (200,000×) (b) magnification. It can be seen that the method according to the invention yielded a good substrate coverage (a). Further the film appeared highly porous with an average pore size of 4.7 (SD 1.0) nm.

### EXAMPLE 2

### Preparation of a Mesoporous TiO₂-Film on a Si-Wafer

The precursor solution was prepared following the same procedure as in the Example 1. The substrate 34 used was a fragment of a silicon wafer. Deposition conditions were as in the Example 1 except that the distance between the tip of the nozzle 20 and the substrate 34 was increased to 16 mm and the deposition time was extended to 24 min. The thermal treatment of deposited film was performed in flowing air following the profile: starting at room temperature; 5 K/min ramp to 80° C.; 80° C. for 4 h; 1 K/min ramp to 600° C.; 600° C. for 0.5 h and cooling to room temperature. XRD analysis failed to verify the presence of crystalline TiO₂. The product was then further calcined at 800° C. for 2 h (using a 3 K/min temperature ramp) and analyzed again by XRD. The diffractograms of the films calcined at 500, 600, 700, and 800° C. are shown in FIG. 3. Diffractograms were background-adjusted by subtraction of a diffractogram collected on an uncoated Si-wafer from the diffractograms collected on coated samples. FIG. 3 shows the appearance of the most intense TiO₂ anatase reflection at 25.3 (101) after calcination at 700° C. Further TiO₂ anatase reflections occur at 37.8° (004), 48.1° (200) and 53.9° (105) after calcination at 800° C. Substrates calcined at 800° C. were further analysed by SEM (FIG. 4). SEM images present evidence of a satisfactory substrate coverage with a pronounced film fracturing (FIG. 4a) and well-defined porous mesostructure with an average pore size of 4.9 (SD 1.0) nm (FIG. 4b). Images were collected at 1000× (a) and 200,000× (b) magnification.

### EXAMPLE 3

### Preparation of a Macroporous TiO₂-Film on a Si-Wafer

Solution A was prepared according to Example 1. For solution C 0.25 mL of 48 wt.-% of PMMA aqueous suspension were added to 20 mL of n-butanol and magnetically stirred for 1 h. 1.0 mL of solution A was added to 4 mL of n-butanol and to their mixture 5.0 mL of solution C were added. The concentrations of the constituents in the resultant precursor solution were 0.005 mol/L of titanium tetraisopropoxide, 3.1 g/L of PMMA and 3.1 g/L of n-butanol. The coating solution was magnetically stirred for 30 min prior to electrospraying.

Spray deposition was done on a fragment of a silicon wafer heated to 80° C. The nozzle 20 was 1.1 mm OD with a tip angle of 21°. The precursor solution was fed through the nozzle 20 with a syringe pump 26 at 1 mL/h rate. The tip of the nozzle 20 was positioned 16 mm below the grounded substrate 34. The potential of 4.0 kV was applied to the nozzle 20 and after a multijet spraying mode was established, the potential was reduced to 3.4 kV changing the mode to a single conejet 36. Deposition was continued for 6 min, then the solution supply and the voltage were cut off and the substrate 34 together with the film which was deposited onto was removed from the holder 22. The precursor solution remained stable during the deposition, no visible precipitate developed in the tubing or in the syringe 26. The sample was thermally treated following the temperature profile as in the Example 1. FIG. 5 shows the SEM images at 1000× (a), 10,000× (b) and 100,000× (c) magnification. The SEM observation revealed that the film gave a good substrate coverage with few fractures (FIG. 5a), an extensive macroporous network (FIG. 5b) and with pores being interconnected to each other (FIG. 5c).

### EXAMPLE 4

### Preparation of a Hierarchically Porous TiO₂-Film on a Si-Wafer

1.0 mL of solution A was added to 1.0. mL of solution B as prepared in Example 1. Then this mixture was added to 3.0 mL of n-butanol and to the resultant mixture 5.0 mL of solution C were added. The concentrations of the constituents in the resultant precursor solution were 0.005 mol/L of titanium tetraisopropoxide, 3.1 g/L of PMMA, 0.71 g/L of Pluronics®.P 123 and 3.1 g/L of n-butanol. The final precursor solution was magnetically stirred for 30 min and then used for electrospraying. The ESD conditions were identical to those provided in the Example 3, the thermal treatment was identical to that detailed in the Example 1.

FIG. 6 shows the morphology and the microstructure of the resultant films studied by SEM. FIG. 6 shows images of the material at low (1000×) (a), medium (10,000×) (b) and high (200,000×) (c) magnification. It can be seen that the film covers the substrate reasonably well although the layers appeared highly textured (FIG. 6a). The medium magnification revealed that the material shows a sponge-like structure with highly open porosity (FIG. 6b). Using the highest magnification it can be seen that the mesopores of 4.0 (SD 0.7) nm in size were extensively present in the walls of the macropores (FIG. 6c).

### LIST OF REFERENCE SIGNS

10 ESD-setup
12 electrostatic spray unit
14 liquid-precursor feed system
16 temperature control block
18 high-DC voltage power supply
20 nozzle
22 grounded substrate holder
24 flexible tube
26 peristaltic or syringe pump
28 heating element
30 temperature controller
32 thermocouple
34 substrate
36 cone jet

1. A method of producing a porous metal oxide film on a substrate comprising
(a) forming a precursor solution comprising a solvent, at least one metal precursor and at least one pore forming organic template
(b) depositing the precursor solution formed in (a) onto a substrate using electrostatic spray deposition process to produce a film and
(c) thermally treating the product obtained in (b) in an atmosphere having an oxygen content from 0 to 50 vol.-% and by following a temperature profile comprising one or more heating ramps, one or more temperature plateaus and one or more cooling ramps.

2. The method according to claim 1, wherein the substrate is pre-treated by applying a passivation layer onto its surface prior to depositing the precursor solution.

3. The method according to claim 1, wherein the deposition of the precursor solution and part of the thermal treatment of the film are performed concurrently.

4. The method according to claim 1, the at least one metal precursor is selected from the group consisting of metal halogenides, metal nitrates, metal sulphates, metal acetates, metal citrates, metal alkoxides, and a mixture thereof.

5. The method according to claim 1, wherein the at least one pore forming organic template is selected from the group consisting of an ionic surfactant, non-ionic surfactant, an amphiphilic block copolymer, a solid organic particle having a mean diameter in the range of 50 nm to 5 μm, and a mixture thereof.

6. The method according to claim 5, wherein the ionic or non-ionic surfactant, the amphiphilic block copolymer or the mixture thereof is used in a concentration being above the critical micelle concentration.

7. The method according to claim 5, wherein the solid organic particles are used in the range of 0.1 to 50 g/l.

8. The method according to claim 5, wherein the amphiphilic block polymer is a di-block, tri-block or multi-block copolymer capable of forming micelles in aqueous and non-aqueous solvents.

9. The method according to claim 5, wherein the solid organic particles are selected from the group consisting of polystyrene, polymethyl methacrylate, styrene-acrylate copolymer, styrene-butadiene-copolymer, nitrile-butadiene-copolymer, pyridine-styrene-butadiene-copolymer particles, and mixtures thereof.

10. The method according to claim 1, wherein the pore forming organic template is a mixture of an amphiphilic block copolymer and solid organic particles in the range of 20:1 to 1:20.

11. The method according to claim 1, wherein the substrate is a material selected from the group consisting of steel, glass, graphite and other material withstanding the thermal treatment.

12. The method according to claim 1, wherein the solvent is a polar organic solvent.

13. A porous film obtainable by the production method according to claim 1.

14. The porous film according to claim 13, wherein the porosity is greater than 60%.

15. (canceled)

16. The method according to claim 4, wherein the at least one metal precursor is a metal alkoxide.

17. The method according to claim 5, wherein the ionic or non-ionic surfactant, the amphiphilic block copolymer, or the mixture thereof is used in a concentration being in the range of 0.01 to 5 g/l.

18. The method according to claim 5, wherein the amphiphilic block polymer is polyethylene oxide-blockpolypropylene oxide-block-polyethylene oxide, polypropylene oxide-block-polyethylene oxide-block-polypropylene oxide, polyethylene oxide-block-polyisobutylene-blockpolyethylene oxide, polyethylene-block-polyethylene oxide, polyisobutylene-block-polyethylene oxide, or a mixture thereof.

19. The method according to claim 5, wherein the solid organic particles are polymethyl methacrylate particles.

20. The method according to claim 1, wherein the pore forming organic template is a mixture of an amphiphilic block copolymer and solid organic particles in the range of 10:1 to 1:10.

21. The method according to claim 12, wherein the solvent is a volatile polar organic solvent or a mixture of two or more volatile organic solvents, or a mixture thereof with water.
